(19) United States
(12) Patent Application Publication
(10) Pub. No.: US 2025/0037475 A1
(43) Pub. Date: Jan. 30, 2025

(54) VEHICLE CONTROL SYSTEM AND OPERATING METHOD THEREOF

(71) Applicant: SAMSUNG ELECTRONICS CO., LTD., Suwon-si (KR)

(72) Inventor: Do Hyun Kim, Suwon-si (KR)

(21) Appl. No.: 18/657,208

(22) Filed: May 7, 2024

(30) Foreign Application Priority Data
Jul. 25, 2023 (KR) 10-2023-0096624

(51) Int. Cl. G06V 20/58; G06V 10/22; G06V 10/26; G06V 10/776; G06V 10/82; G06V 10/98

(52) U.S. Cl. CPC G06V 20/58; G06V 10/225; G06V 10/26; G06V 10/776; G06V 10/82; G06V 10/98

(57) ABSTRACT

A vehicle control system comprises an image signal processor (ISP), a first neural processing unit (NPU), a second NPU, a data processing circuit, and sensors mounted on a vehicle. The ISP receives a first image and processes it to generate a second image. The first NPU and the second NPU both independently segment the second image to identify a type of the object and produce data related to the object. The data processing circuit receives data from both NPUs and sensor data from the sensors and determines whether either of the first NPU or the second NPU is abnormal by comparing correlations between the NPU data and the sensor data during a first frame interval.

### CROSS-REFERENCE TO RELATED APPLICATION

This application claims priority to Korean Patent Application No. 10-2023-0096624 filed on Jul. 25, 2023 in the Korean Intellectual Property Office under 35 U.S.C. 119, the entire contents of which are herein incorporated by reference.

### BACKGROUND

The present disclosure relates to a vehicle control system, an automotive system including the vehicle control system, and a method for operating the same.

In recent years, automobiles are rapidly becoming smarter due to the fusion of information and communication technology and the automobile industry. Accordingly, automobiles are evolving from simple mechanical devices into smart cars, and in particular, an Advanced Driver Assistance System (ADAS) and an Automatic Driving (AD) system are attracting attention as core technologies for the smart cars.

For the ADAS and the AD system, various technologies are used, such as a technology for recognizing the vehicle's driving environment including other nearby vehicles and pedestrians, technology for determining the vehicle's driving situation, and control technology such as vehicle's driving, startup, and steering. These technologies may rely on accurately and efficiently recognizing and detecting objects around the vehicle, using, e.g., artificial intelligence.

### SUMMARY

In general, in some aspects, the present disclosure relates to vehicle control systems for improving the stability of an autonomous vehicle.

In general, in some aspects, the present disclosure relates to automotive systems for improving the stability of the autonomous vehicle.

In general, in some aspects, the present disclosure relates to methods for operating the vehicle control system for improving the stability of the autonomous vehicle.

However, aspects of the present disclosure are not restricted to the examples set forth herein. The above and other aspects of the present disclosure will become more apparent to one of ordinary skill in the art to which the present disclosure pertains by referencing the detailed description of the present disclosure given below.

In general, in some aspects, the present disclosure relates to a vehicle control system that comprises an image signal processor (ISP), which is configured to receive a first image obtained by capturing an object around a vehicle during a predetermined frame interval and to process the first image to generate a second image. The vehicle control system also comprises a first neural processing unit (NPU), which is configured to: receive the second image from the ISP; perform a first image segmentation on the second image to identify a type of the object; and generate first data about a numerical value of a region occupied by the object within the second image. The vehicle control system also comprises a second NPU, which is configured to: receive the second image from the ISP; perform a second image segmentation on the second image to identify the type of the object; and generate second data about the numerical value of the region occupied by the object within the second image. The vehicle control system also comprises a data processing circuit, which is configured to: receive each of the first and second data from the first and second NPUs; receive sensing data about a driving state of the vehicle during the predetermined frame interval from a sensing system mounted on the vehicle; and then process the first and second data and the sensing data to determine whether each of the first and second NPUs is abnormal. The data processing circuit is configured to learn a correlation between an amount of change in the first data during the first frame interval and an amount of change in the sensing data during the first frame interval, in response to the fact that the amount of change in the first data during the first frame interval is equal to the amount of change in the second data during the first frame interval.

In general, in some aspects, the present disclosure relates to an automotive system comprising a camera, which is configured to capture an object around a vehicle during a predetermined frame interval to generate a first image, a sensing system, which is configured to sense data related to a driving state of the vehicle during the predetermined frame interval to generate sensing data, and a vehicle control system, which is configured to control the vehicle based on the first image. The vehicle control system includes an image signal processor (ISP), which is configured to process the first image to generate a second image. The vehicle control system includes a first neural processing unit (NPU), which is configured to receive the second image from the ISP; performs a first image segmentation on the second image to identify a type of the object; and generate a first data about a numerical value of a region occupied by the object within the second image. The vehicle control system includes a second NPU, which is configured to receive the second image from the ISP; perform a second image segmentation on the second image to identify the type of the object; and generate a second data about the numerical value of the region occupied by the object within the second image. The vehicle control system includes a data processing circuit, which is configured to receive each of the first and second data from the first and second NPUs; receive the sensing data from the sensing system; and then process the first and second data and the sensing data to determine whether each of the first and second NPUs is abnormal. Based on an amount of change in the first data during a first frame interval being equal to an amount of change in the second data during the first frame interval, the data processing circuit is configured to learn a correlation between the amount of change in the first data during the first frame interval and the amount of change in the sensing data during the first frame interval.

In general, in some aspects, the present disclosure is related to a method for operating a vehicle control system, in which the method includes receiving a first image obtained by capturing an object around a vehicle during a predetermined frame interval, and processing the first image to generate a second image by an image signal processor (ISP). The method also comprises receiving, by a first neural processing unit (NPU), the second image from the ISP, performing a first image segmentation on the second image to identify a type of the object, and generating a first data about a numerical value of a region occupied by the object within the second image. The method also comprises receiving, by a second NPU, the second image from the ISP, performing a second image segmentation on the second image to identify the type of the object, and generating a second data about the numerical value of the region occupied by the object within the second image. The method also comprises receiving, by a data processing circuit, each of the first and second data from the first and second NPUs, and a plurality of pieces of sensing data about a driving state of the vehicle during the predetermined frame interval from a sensing system mounted on the vehicle and, based on an amount of change in the first data during a first frame interval being equal to an amount of change in the second data during the first frame interval, calculating, by the data processing circuit, each correlation between the amount of change in the first data during the first frame interval and the amount of change in each of the plurality of the sensing data during the first frame interval. The method also comprise storing, by the data processing circuit, an item of first sensing data that is determined to have a correlation with the amount of change in the first data during the first frame interval, among the plurality of pieces of sensing data.

It should be noted that the effects of the present disclosure are not limited to those described above, and other effects of the present disclosure will be apparent from the following description.

### BRIEF DESCRIPTION OF THE DRAWINGS

FIG. 1 is an diagram showing an example of a vehicle control system.

FIG. 2 is a diagram showing an example of a automotive system including the vehicle control system of FIG. 1.

FIG. 3 is a diagram showing an example of a vehicle control system mounted in a vehicle.

FIG. 4 is a diagram showing an example of an NPU in the vehicle control system of FIG. 3 performing image segmentation.

FIG. 5 is an flowchart depicting an example of operation of the automotive system of FIG. 2.

FIGS. 6 and 7 are diagrams showing examples of an NPU performing image segmentation to generate data among the steps of FIG. 5.

FIG. 8 is a flowchart depicting an example of operation of a vehicle control system.

FIG. 9 is a diagram depicting an example of operation of the vehicle control system of FIG. 8.

FIG. 10 is an flowchart depicting an example of operation of a vehicle control system.

FIG. 11 is a schematic illustrating an example of a vehicle including a vehicle control system.

### DETAILED DESCRIPTION

A vehicle control system, an automotive system including the vehicle control system, and a method for operating the same are described below with reference to the accompanying drawings.

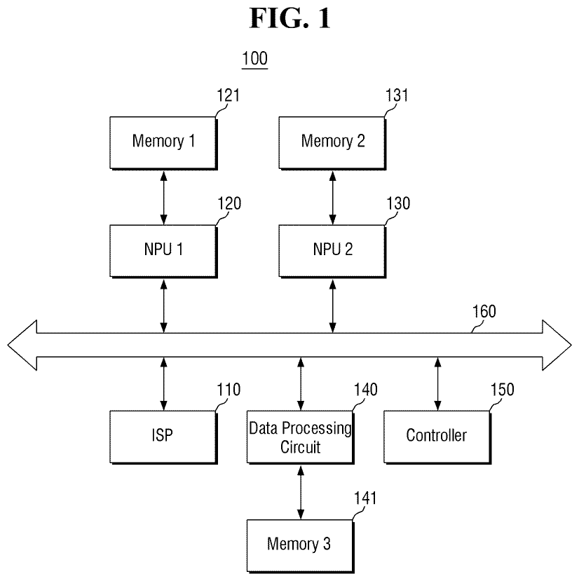

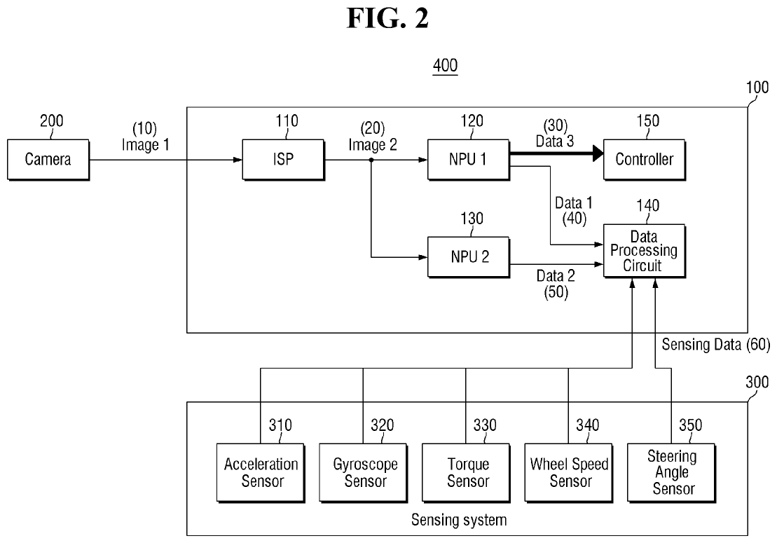

FIG. 1 is an example diagram showing a vehicle control system. FIG. 2 is an exemplary diagram showing an automotive system including the vehicle control system of FIG. 1. Hereinafter, the vehicle control system and the automotive system will be described with reference to FIGS. 1 and 2.

An automotive system 400 may include a camera 200, a vehicle control system 100, and a sensing system 300. The camera 200 may be mounted on a vehicle, and may include an image sensor that senses objects around the vehicle by the use of light to generate image signals. The camera 200 may generate the image 10 by capturing images of a plurality of objects around the vehicle, including objects in front of the vehicle.

The vehicle control system 100 may be an ADAS (Advanced Driver Assistance System) or an automatic driving system installed in the vehicle. The vehicle control system 100 may be implemented as an integrated circuit (IC), a system on chip (SOC) or an application processor (AP). The vehicle control system 100 may include an image signal processor (ISP), a first NPU (neural processing unit) 120, a second NPU 130, a data processing circuit 140, a controller 150, memories 121, 131 and 141, and a bus 160. However, the vehicle control system 100 may further include other configurations (for example, IP (Intellectual Property)), in addition to the configurations shown in FIGS. 1 and 2.

The ISP 110 may receive the image 10 from the camera 200 and process the image 10 to generate an image 20. For example, the ISP 110 may receive the image 10 output from the image sensor of the camera 200, and fabricate or process the received image 10 to facilitate recognition and processing by the NPUs 120 and 130. In some implementations, the ISP 110 may perform digital binning on the image 10 that is output from the image sensor. At this time, the image 10 that is output from the image sensor may be a raw image signal that is output from the pixel array of the image sensor without analog binning, or may be an image signal subjected to analog binning.

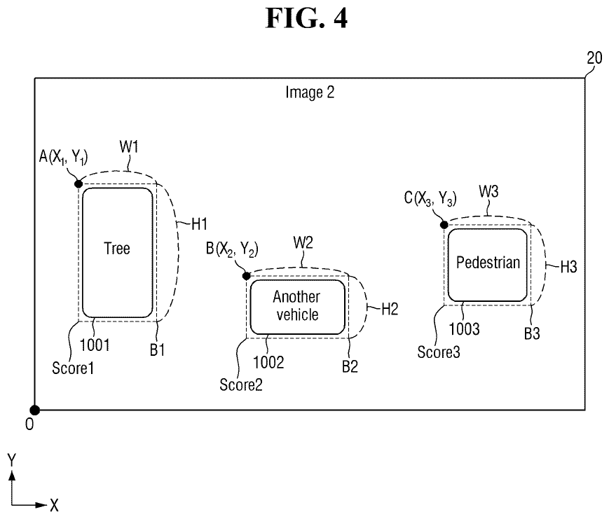

The first NPU 120 may receive the image 20 from the ISP 110, identify information of the objects included in the received image 20, and generate selected data 30 about the identified information of the objects. For example, the first NPU 120 may perform an image segmentation on the received image 20 to generate bounding boxes for each object within the image 20. The operations of the NPUs 120 and 130 will be described in detail later with reference to FIG. 4 or the like.

In this way, the first NPU 120 may receive the image 20 about objects around the vehicle from the ISP 110, perform a neural network operation based on the image 20, and generate an information signal (i.e., selected data 30) about the results obtained by recognizing the image 20. At this time, the selected data 30 generated by the first NPU 120 may be information that serves as a reference when the controller 150 controls the autonomous vehicle. For example, the selected data 30 generated by the first NPU 120 based on the image 20 received from the ISP 110 may be transferred to the controller 150, and the controller 150 may control the autonomous vehicle based on the selected data 30 received from the first NPU 120.

The first NPU 120 may also transfer first data 40 generated based on the image received from the ISP 110 to the data processing circuit 140. In some implementations, the first data 40 may correspond to some of the selected data 30. That is, the first NPU 120 may transmit all (that is, the selected data 30) of the information signals about the result obtained by recognizing the image 20 received from the ISP 110 to the controller 150, and may transmit the first data 40 corresponding to some of the information signals to the data processing circuit 140. For example, the first NPU 120 may transmit only the first data 40 corresponding to highly reliable data among the generated selected data 30 to the data processing circuit 140. The criteria of the reliability described above will be described later with reference to FIG. 4 or the like.

The second NPU 130 may include the same configuration as that of the first NPU 120, and may perform the same functions as the first NPU 120. For example, like the first NPU 120, the second NPU 130 may receive the image 20 from the ISP 110, and perform the image segmentation or the like on the received image 20. In some implementations, the first NPU 120 and the second NPU 130 may each receive images 20 from the ISP 110 and perform the image segmentation in parallel. That is, the operations of the first NPU 120 and the second NPU 130 for performing the image segmentation on the image 20 may occur independently of each other.

In addition, in parallel with the operation of transmitting the selected data 30 generated by the first NPU 120 to the controller 150 and the operation of transmitting the first data 40 corresponding to some of the selected data 30 generated by the first NPU 120 to the data processing circuit 140, the second NPU 130 may independently transfer the second data 50 generated by performing the image segmentation to the controller 150. In some implementations, the second data 50 may correspond to some of highly reliable data generated by performing the image segmentation by the second NPU 130. The criteria of reliability described above will be described later with reference to FIG. 4 or the like.

In some implementations, the controller 150 may also control the autonomous vehicle based on data received from the second NPU 130 in addition to data received from the first NPU 120. For example, if there is an abnormality in the operation of the first NPU 120, the controller 150 may control the autonomous vehicle based on data received from the second NPU 130. In this way, the vehicle control system 100 may include two or more NPUs that perform the same function. Alternatively, the vehicle control system 100 may further include at least one NPU that performs a different function from those of the NPUs 120 and 130. Hereinafter, a case in which the vehicle control system 100 includes two NPUs 120 and 130 that perform the same function will be described as an example.

In some implementations, the first NPU 120 and the second NPU 130 may be divided into a main NPU and a sub NPU inside the vehicle control system 100. For example, the main NPU may perform a neural network operation based on the image 20 received from the ISP 110, and transmit the executed result to the controller 150. On the other hand, like the main NPU, the sub NPU may perform the neural network operations based on the image 20 received from the ISP 110, but may not transmit the executed results to the controller 150. Therefore, the controller 150 may control the autonomous vehicle based on only the information received from the main NPU.

However, if the main NPU is out of order or not operating normally, the sub NPU may transmit the results obtained by performing the neural network operation to the controller. At this time, the main NPU may not transmit the data to the controller 150, and thus, the controller 150 may control the autonomous vehicle based on only the data received from the sub NPU. Hereinafter, an example will be described in which the first NPU 120 is the main NPU and the second NPU 130 is the sub NPU.

The data processing circuit 140 may receive each of first data 40 and second data 50 from the first NPU 120 and the second NPU 130. Further, the data processing circuit 140 may receive sensing data 60 about the driving state of the vehicle from the sensing system 300. The data processing circuit 140 may process the received first data 40 and 50 and the sensing data 60 to determine whether the first NPU 120 and the second NPU 130 operate normally.

For example, the data processing circuit 140 may determine whether both the first NPU 120 and the second NPU 130 operate normally based on the first data 40 and the second data 50. When it is determined that both the first NPU 120 and the second NPU 130 operate normally, the data processing circuit 140 may learn a correlation between an amount of change in first data 40 during a predetermined frame interval and an amount of change in sensing data 60 during a predetermined frame interval, based on the first data 40 generated by the first NPU 120 corresponding to the main NPU and the sensing data 60. In some implementations, when a plurality of pieces of sensing data 60 are received from the sensing system 300, the data processing circuit 140 may learn multiple correlations between the amount of change in first data 40 during a predetermined frame interval and the amounts of change in each of the plurality of pieces of sensing data 60 during a predetermined frame interval.

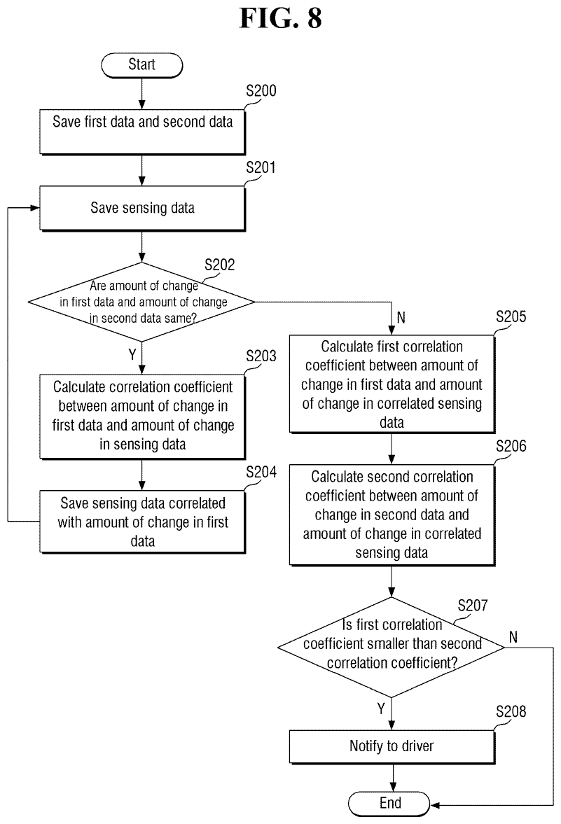

Further, the data processing circuit 140 may determine that either the first NPU 120 or the second NPU 130 operates abnormally based on the first data 40 and the second data 50. When it is determined that either the first NPU 120 or the second NPU 130 operates abnormally, the data processing circuit 140 may discern the NPU that operates abnormally among the first NPU 120 and the second NPU 130 based on the result of the correlation learning. The operation of performing the correlation learning and the operation of discerning the abnormally operating NPU by the data processing circuit 140 will be described later with reference to FIG. 8.

In some implementations, the data processing circuit 140 may be implemented as a digital signal processor (DSP), a NPU, core, and the like. For example, the data processing circuit 140 may be an extra core inside a big core for AP application.

Memories 121, 131, and 141 may be used as main memory or system memory of the vehicle control system 100. The memory 121 may be connected to the first NPU 120, the memory 131 may be connected to the second NPU 130, and the memory 141 may be connected to the data processing circuit 140. For example, each of the memories 121, 131, and 141 may temporarily store data or signals to be transferred to the first NPU 120, the second NPU 130, and the data processing circuit 140, and may temporarily store data or signals generated by the first NPU 120, the second NPU 130, and the data processing circuit 140.

In some implementations, each of the memories 121, 131, and 141 may include, but not be limited to, a volatile memory such as a dynamic random access memory (DRAM), a static random access memory (SRAM), and a synchronous dynamic random access memory (SDRAM). For example, the memories 121, 131, and 141 may include a non-volatile memory such as a flash memory, a flash change RAM (PRAM), a resistive RAM (RRAM), and a magnetic RAM (MRAM).

When the first NPU 120 corresponding to the main NPU operates normally, the controller 150 may control driving, maneuvering, steering, and the like of the vehicle based on the selected data 30 received from the first NPU 120. For example, the controller 150 may be ADAS function software. As mentioned above, the controller 150 may control the vehicle based on the selected data 30 received from the first NPU 120 when the first NPU 120 corresponding to the main NPU operates normally. However, the controller 150 may control the vehicle based on data received from the second NPU 130 corresponding to the sub NPU when it is determined that the main NPU operates abnormally by the data processing circuit 140.

The components 110, 120, 130, 140, and 150 included in the vehicle control system 100 may communicate with each other through an interconnection such as a bus 160.

The sensing system 300 may include a plurality of sensors 310, 320, 330, 340, and 350. The plurality of sensors 310, 320, 330, 340, and 350 are mounted on the vehicle, and may sense the state of the vehicle and generate sensing data 60 including information about the driving state of the vehicle. However, the types of sensors included in the sensing system 300 are not limited to those shown in FIG. 2. The plurality of sensors 310, 320, 330, 340, and 350 include an accelerator sensor 310, a gyroscope sensor 320, a torque sensor 330, a wheel speed sensor 340, a steering angle sensor 350, and the like. In addition, the sensing system 300 may include a collision sensor, a speed sensor, a tilt sensor, a weight perception sensor, a heading sensor, a position module, a vehicle forward/reverse sensor, a battery sensor, a fuel sensor, a tire sensor, a vehicle internal temperature sensor, a vehicle internal humidity sensor, an ultrasonic sensor, an illuminance sensor, an accelerator pedal position sensor, a brake pedal position sensor, and the like. The sensing system 300 may transmit at least one of the sensed data sensed by the aforementioned sensors to the data processing circuit 140.

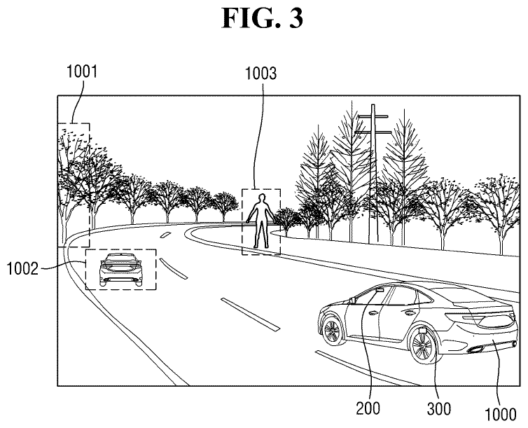

FIG. 3 is a diagram showing an example in which a vehicle control system is installed in a vehicle. FIG. 4 is an exemplary diagram in which the NPU included in the vehicle control system of FIG. 3 executes the image segmentation. Hereinafter, an example in which the NPU included in the vehicle control system performs the image segmentation will be explained with reference to FIGS. 3 and 4.

Referring first to FIG. 3, the vehicle control system 100 (shown in FIG. 1) may be an ADAS, an automatic driving system installed in the vehicle 1000, and a camera 200 and a sensing system 300 may be mounted on the vehicle 1000. The vehicle control system 100 may receive images from the camera 200 installed in front of the vehicle 1000, but implementations are not limited thereto. For example, the vehicle control system 100 may receive images from a camera that may capture images of the surroundings of the vehicle 1000. The surroundings of the vehicle 1000 may include, for example, a front, a side, and a rear of the vehicle.

In some implementations, the camera 200 may image a plurality of objects located in front of the traveling vehicle 1000 during a predetermined frame interval. In FIGS. 3 and 4, among a plurality of objects located in front of the vehicle 1000, a tree 1001, another vehicle 1002, and a pedestrian 1003 will be explained examples. The plurality of objects may have a static speed (e.g., the tree 1001) or may have a dynamic speed (e.g., another vehicle 1002).

Next, referring to FIG. 4, the image 20 may be an image obtained by fabricating and processing by the ISP 110 such that the image (10, shown in FIG. 2) captured by the camera 200 may be recognized by the first NPU 120 and the second NPU 130. As mentioned above, the first NPU 120 and the second NPU 130 perform the same function, and the explanation will be given by an example in which the first NPU 120, corresponding to the main NPU, performs the image segmentation. However, it goes without saying that the following explanation may be similarly applied to a case where the second NPU 130 corresponding to the sub NPU performs the image segmentation.

After the first NPU 120 receives the image 20 from the ISP 110, it may perform image segmentation on the image 20. The image segmentation may be a process of assigning label information to each pixel of a two-dimensional image. For example, the first NPU 120 may generate bounding boxes B1, B2, and B3 for recognizing and separating the objects on the plurality of objects 1001, 1002, and 1003 included in the image 20. The bounding box may be a box of the smallest size which may include the shapes of all objects in the image. The label information may include information about the type of object within the bounding box.

For example, the first NPU 120 may generate a bounding box BI for the tree 1001, and may identify that the object within the bounding box B1 is a tree. Similarly, the first NPU 120 may generate each of bounding boxes B2 and B3 for another vehicle 1002 and the pedestrian 1003, and identify that the objects in the bounding boxes B2 and B3 are another vehicle and pedestrian.

In this way, the bounding box may correspond to a region occupied by the object within image 20, and the first NPU 120 may define positions of each object within the image 20 through the bounding box. However, the embodiment is not limited thereto, and the first NPU 120 may receive a 3D image from the ISP 110, generate a bounding box for each object in the 3D image, and assign label information of each pixel.

In some implementations, the first NPU 120 may identify the type of each object for each object included in the bounding boxes B1, B2, and B3, and tag a confidence score for the confidence of the identification result to each of the bounding boxes B1, B2, and B3. For example, the first NPU 120 may identify that the object included in the bounding box B1 is a tree 1001, and tag a confidence score thereof (score 1) to the bounding box B1.

The first NPU 120 may determine that the reliability score is high when the reliability score is equal to or greater than a predetermined threshold value. For example, if the reliability score (score 2) tagged to the bounding box B2 is equal to or greater than the predetermined threshold value, the first NPU 120 may determine that the reliability obtained by identifying the type of object included in the bounding box B2 is high. Alternatively, the first NPU 120 identifies that the object included in the bounding box B3 is the pedestrian 1003, and tags the corresponding confidence score (score 3) to the bounding box B3, but the confidence score may be equal to or less than the predetermined threshold value. In this way, when the confidence score tagged to the bounding box is equal to or less than a predetermined threshold value, the type of object included in the corresponding bounding box identified by the first NPU 120 may differ from the type of object actually included in that bounding box.

In some implementations, the first NPU 120 may generate data about the numerical value of the region occupied by the objects 1001, 1022, and 1003 within the image 20. For example, the first NPU 120 may identify the reference coordinates of each of the bounding boxes B1, B2, and B3, the lengths of each of the bounding boxes B1, B2, and B3 in the first direction X, and the lengths of each of the bounding boxes B1, B2, and B3 in the second direction Y, and generate data about the reference coordinates and the lengths. Hereinafter, the reference coordinates A and lengths W1 and H1 of the bounding box B1 will be explained as examples, but it goes without saying that the same explanation is also applicable to the reference coordinates B and lengths W2 and H2 of the bounding box B2 and the reference coordinates C and length W3 and H3 of the bounding box B3.

For example, the reference coordinate A of the bounding box B1 may be any of the four vertices of the bounding box B1. In some implementations, as shown in FIG. 4, the reference coordinates of the bounding box B1 may be, but not limited to, coordinates (X₁, Y₁) of a vertex A corresponding to a top left of the bounding box B1. Further, the first NPU 120 may generate data about a length W1 in the first direction X, which corresponds to the width of the bounding box B1, and a length H1 in a second direction Y perpendicular to the first direction X, which corresponds to the height of the bounding box B1.

In this way, the first NPU 120 may perform the image segmentation on the plurality of objects 1001, 1002, and 1003 within the image 20 received from the ISP 110, form a bounding box for each of the plurality of objects, after identifying the type of object within the bounding box, tag a confidence score to the bounding boxes, and generate data about the reference coordinates of each bounding box and the widths and heights of each bounding box.

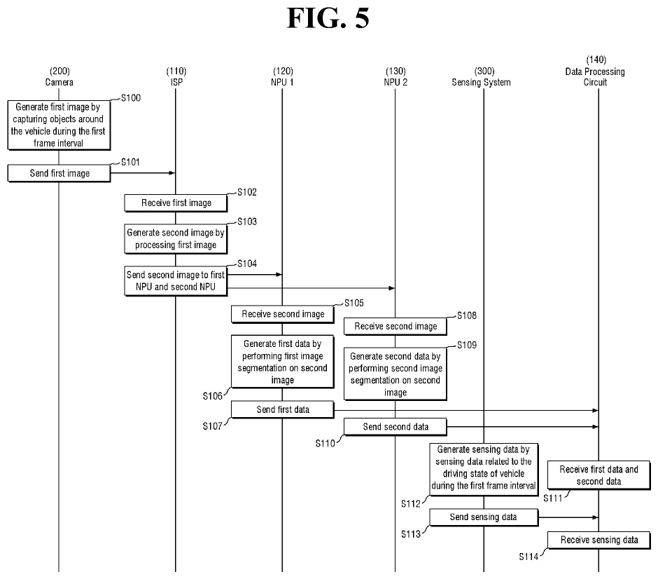

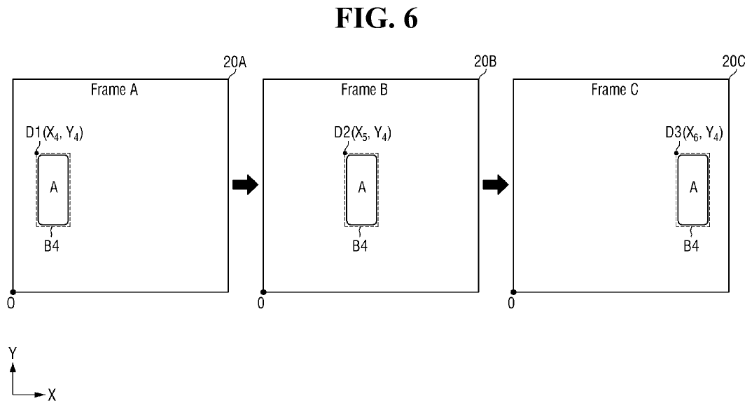

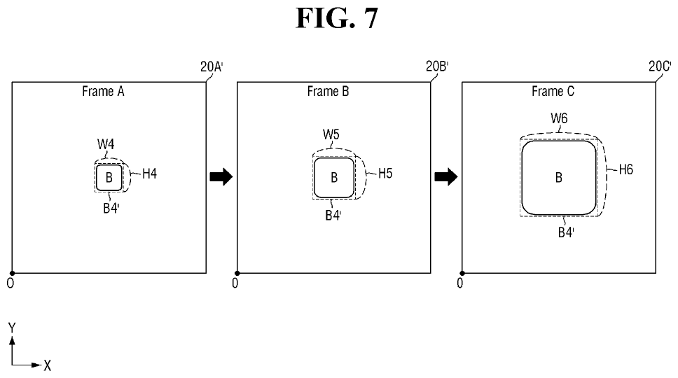

FIG. 5 is an exemplary flowchart for explaining the operation of the automotive system of FIG. 2. FIGS. 6 and 7 are exemplary diagrams for explaining a step in which the NPU performs the image segmentation to generate data among the steps of FIG. 5. Hereinafter, with reference to FIGS. 5 to 7, an operation will be explained in which the data processing circuit 140 receives first data generated by performing the image segmentation during the first frame interval by the first NPU 120, and second data generated by performing the image segmentation during the first frame interval by the second NPU 130. In addition, below, in order to distinguish the image segmentations performed by the first NPU 120 and the second NPU 130, the image segmentations performed by the first NPU 120 and the second NPU 130 will be defined as a first image segmentation and a second image segmentation, respectively.

First, the camera 200 mounted on the vehicle 1000 (shown in FIG. 3) may capture objects around the vehicle 1000 during a first frame interval to generate an image 10 (S100). In some implementations, the first frame interval may be, but not be limited to, 100 to 150 milliseconds. The image 10 may include a plurality of images obtained by capturing the objects around the vehicle 1000 during the first frame interval. Subsequently, the camera 200 may transmit the generated image 10 to the ISP 110 (S101).

The ISP 110 may receive the image 10 from the camera 200 (S102), and process the image 10 to generate the image 20 (S103). The image 20 may include a plurality of images obtained by processing a plurality of images 10 obtained by capturing the objects around the vehicle 1000 during the first frame interval. After that, the ISP 110 may transmit the generated image 20 to each of the first NPU 120 and the second NPU 130 (S104).

The first NPU 120 may receive the image 20 from the ISP 110 (S105), and perform the first image segmentation on the image 20 to generate first data 40 (S106). The first data 40 generated by the first NPU 120 may include at least one of a bounding box generated for the object included in the image 20 by performing the first image segmentation on the image 20, information about the type of object included in the bounding box, the confidence score about the type of object tagged to the bounding box, reference coordinates of the bounding box, and information about the width and height of the bounding box. Subsequently, the first NPU 120 may transmit the first data 40 to the data processing circuit 140 (S107).

In some implementations, when the image 20 includes the plurality of objects, the first NPU 120 may generate a plurality of pieces of selected data 30 corresponding to each of the plurality of objects. At this time, the first NPU 120 may transmit only the first data 40 corresponding to the object with a high reliability score among the plurality of generated selected data 30 to the data processing circuit 140. However, the embodiment is not limited thereto, and the first NPU 120 may transmit all of the plurality of pieces selected data 30 corresponding to each of the plurality of objects generated by performing the first image segmentation to the data processing circuit 140.

The second NPU 130 may receive image 20 from the ISP 110 (S108), and perform the second image segmentation on the image 20 to generate second data 50 (S109). The second data 50 generated by the second NPU 130 may include at least one of a bounding box generated for the object included in the image 20 by performing the second image segmentation on the image 20, information about the type of object included in the bounding box, a confidence score about the type of object tagged to the bounding box, reference coordinates of the bounding box, and information about the width and height of the bounding box.

Further, the second data 50 may correspond to some of the data generated by performing a second image segmentation by the second NPU 130. For example, when the image 20 includes a plurality of objects, the second NPU 130 may generate a plurality of pieces of second data 50 corresponding to each of the plurality of objects. At this time, the second NPU 130 may transmit only the second data 50 corresponding to the object with a high reliability score among the plurality of generated second data 50 to the data processing circuit 140. However, the embodiment is not limited thereto, and the second NPU 130 may transmit all of the plurality of pieces of second data 50 corresponding to each of the plurality of objects generated by performing the second image segmentation to the data processing circuit 140.

Subsequently, the second NPU 130 may transmit the second data 50 to the data processing circuit 140 (S110). Therefore, the data processing circuit 140 may receive the first data 40 and the second data 50 (S111).

In some implementations, the operations in which the first NPU 120 and the second NPU 130 each receive the image 20 from the ISP 110 and perform the first and second image segmentations to generate the first data 40 and the second data 50 may be performed in parallel.

In parallel with the operation of generating the first data 40 and the second data 50 by the first NPU 120 and the second NPU 130, the sensing system 300 may sense data about the driving state of vehicle 1000 during the same frame interval as the first frame interval at which the camera 200 captures the object to generate the sensing data 60 (S112). The sensing system 300 may transmit the generated sensing data to the data processing circuit 140 (S113). Therefore, the data processing circuit 140 may receive the sensing data 60 (S114).

Next, referring to FIG. 6, FIG. 6 is an exemplary diagram showing that the first NPU 120 performs a first image segmentation when the vehicle 1000 (shown in FIG. 3) makes a left turn during a first frame interval. Hereinafter, FIGS. 6 and 7 explain a case in which the first NPU 120 performs the first image segmentation on the images during the first frame interval as an example, but it goes without saying that the following explanation is also similarly applicable to the case where the second NPU 130 performs the second image segmentation on the images during the first frame interval.

The images 20A, 20B, and 20C may be images sequentially received from the ISP 110 by the first NPU 120. In some implementations, the first frame interval may include three consecutive frames, e.g., a frame A, a frame B, and a frame C. The frame A, the frame B, and the frame C may represent the same frame in chronological order. At this time, the image 20A may correspond to the frame A, the image 20B may correspond to the frame B, and the image 20C may correspond to the frame C. Hereinafter, a case in which the object A has a static speed and the first NPU 120 operates normally will be explained.

When the vehicle 1000 makes a left turn, the object A, which has a static velocity, moves relatively to the right within the same frame. As a result, an X value of the reference coordinates of the bounding box B4 (for example, the coordinates corresponding to the top left of the bounding box B4) may become increasingly large as time passes. For example, an X value X₄ of the reference coordinate D1 of the bounding box B4 in the frame A may be smaller than an X value X₅ of the reference coordinate D2 of the bounding box B4 in the frame B. The X value X₅ of the reference coordinate D2 of the bounding box B4 in the frame B may be smaller than an X value X₆ of the reference coordinate D3 of the bounding box B4 in the frame C.

The first NPU 120 may transmit each of the X value X₄ of the reference coordinate D1 of the bounding box B4 in the frame A, the X value X₅ of the reference coordinate D2 of the bounding box B4 in the frame B, and the X value X₆ of the reference coordinate D3 of the bounding box B4 in the frame C to the data processing circuit 140. Accordingly, the data processing circuit 140 may calculate the amount of change in the reference coordinates of the bounding box B4 during the first frame interval.

At this time, the sensing system 300 may transmit sensing data 60 generated by sensing data related to the driving state of the vehicle 1000 during the first frame interval to the data processing circuit 140. For example, when the vehicle 1000 makes a left turn, a torque of the vehicle 1000 that is input from the torque sensor 330 may become increasingly large, and a steering angle sensor input of the vehicle 1000 that is input from the steering angle sensor 350 may become increasingly large. Furthermore, the wheel speed sensor input of the vehicle 1000 that is input from the wheel speed sensor 340 may be relatively larger on the right wheel of the vehicle than on the left wheel. Further, a lateral acceleration value of the acceleration sensor 310 and a yaw value of the gyroscope sensor 320 that are input from the acceleration sensor 310 and the gyroscope sensor 320 may become increasingly large.

In this way, the data processing circuit 140 may calculate the amount of change in each sensing data of the first frame interval, based on the sensing data during the first frame interval received from the sensing system 300.

Next, referring to FIG. 7, FIG. 7 is an exemplary diagram showing that the first NPU 120 performs the first image segmentation when the vehicle 1000 accelerates during the first frame interval. Images 20A′, 20B′, and 20C′ may be images that are sequentially received from the ISP 110 by the first NPU 120. An image 20A′ may correspond to the frame A, an image 20B′ may correspond to the frame B, and an image 20C′ may correspond to the frame C. Hereinafter, a case in which the object B has a static speed and the first NPU 120 operates normally will be explained as an example.

When the vehicle 1000 accelerates, the object B having a static speed becomes closer to the vehicle 1000 and therefore becomes relatively larger within the same frame. Accordingly, the width and length of the bounding box B4′ may become increasingly large. For example, a length W4 in the first direction X of the bounding box B4′ in the frame A and a length H4 in the second direction Y perpendicular to the first direction X may be smaller than a length W5 in the first direction X and a length H5 in the second direction Y of the bounding box B4′ in the frame B. The length W5 in the first direction and the length H5 in the second direction Y of the bounding box B4′ in the frame B may be smaller than the length W6 in the first direction X and the length H6 in the second direction Y of the bounding box B4′ in the frame C.

The first NPU 120 may transmit the length W4 in the first direction X and the length H4 in the second direction Y of the bounding box B4′ in the frame A, the length W5 in the first direction X and the length H5 in the second direction Y of the bounding box B4′ in the frame B, and the length W6 in the first direction X and the length H6 in the second direction Y of the bounding box B4′ in the frame C to the data processing circuit 140. Therefore, the data processing circuit 140 may calculate the amount of change in the length in the first direction X of the bounding box B4′ during the first frame interval and the amount of change in the length in the second direction Y of the bounding box B4′ during the first frame interval.

At this time, the sensing system 300 may sense data related to the driving state of the vehicle 1000 during the first frame interval, and transmit the generated sensing data to the data processing circuit 140. For example, when the vehicle 1000 accelerates, the wheel speed sensor input value of the vehicle 1000 that is input from the wheel speed sensor 340 may increase on both the left wheel and right wheel of the vehicle 1000. Furthermore, the longitudinal acceleration value of the acceleration sensor 310 and the pitch value of the gyroscope sensor 320 that are input from the acceleration sensor 310 and the gyroscope sensor 320 may become increasingly large or small, depending on determine whether the driving wheels of the vehicle 1000 are the front wheels or rear wheels.

In this way, the data processing circuit 140 may calculate the amount of change in each sensing data of the first frame interval based on the sensing data during the first frame interval received from the sensing system 300.

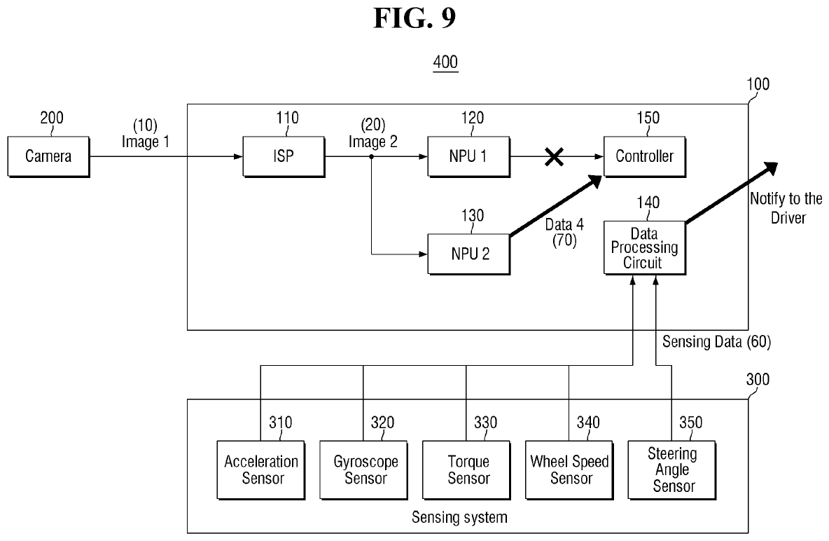

FIG. 8 is an exemplary flowchart for explaining the operation of the vehicle control system. FIG. 9 is an exemplary diagram for explaining the operation of the vehicle control system of FIG. 8. The operation of the vehicle control system is described below with reference to FIGS. 8 and 9. Reference numbers in the following description may be the same as reference numbers in the drawings referred to above.

First, referring to FIG. 8, the data processing circuit 140 may store the first data 40 and the second data 50 received from the first NPU 120 and the second NPU 130 in the memory 141 (S200). For example, the data processing circuit 140 may store the first data 40 during the first frame interval and the second data 50 during the first frame interval in the memory 141. Further, the data processing circuit 140 may store the sensing data 60 received from the sensing system 300 in the memory 141 (S201). For example, the data processing circuit 140 may store the sensing data 60 during the first frame interval in the memory 141. At this time, the sensing data 60 may include a plurality of pieces of sensing data sensed by the plurality of sensors 310, 320, 330, 340, and 350 during the first frame interval.

Next, the data processing circuit 140 may compare whether the amount of change in the first data 40 and the amount of change in the second data 50 are equal to each other (S202). For example, when the data processing circuit 140 receives the first data 40, the second data 50, and the sensing data 60 during the first frame interval, the data processing circuit 140 may calculate each of the amount of change in the first data 40 during the first frame interval, the amount of change in the second data 50 during the first frame interval, and the amount of change in the sensing data 60 during the first frame interval. The data processing circuit 140 may compare the amount of change in the first data 40 during the first frame interval with the amount of change in the second data 50 during the first frame interval, and compare whether both the amounts of change shows a similar tendency.

If the amount of change in the first data 40 during the first frame interval and the amount of change in the second data 50 during the first frame interval show the same or similar tendency (S202—Y), the data processing circuit 140 may calculate a correlation coefficient R between the amount of change in the first data 40 during the first frame interval and the amount of change in the sensing data 60 during the first frame interval (S203). When the sensing data 60 includes a plurality of pieces of sensing data, the data processing circuit 140 may calculate the correlation coefficients of the multiple correlations for each item of the sensing data 60.

For example, the data processing circuit 140 may calculate the correlation coefficient R between the amount of change in the first data 40 during the first frame interval and the amount of change in the data sensed from the torque sensor 330 during the first frame interval, and may calculate the correlation coefficient R between the amount of change in the first data 40 during the first frame interval and the amount of change in the data sensed from the wheel speed sensor 340 during the first frame interval.

Subsequently, the data processing circuit 140 may store items of sensing data that are determined to have a correlation with the amount of change in the first data 40 during the first frame interval (i.e., correlated sensing data) (S204). In this way, when the amount of change in the first data 40 generated by the first NPU 120 and the amount of change in the second data 50 generated by the second NPU 130 during a predetermined frame interval show the same or similar tendency, the data processing circuit 140 may determine that both the first NPU 120 and the second NPU 130 operate normally, and learn the correlation (or multiple correlations) between the amount of change in the first data 40 generated by the first NPU 120 corresponding to the main NPU during the predetermined frame interval and the amount of change in the sensing data 60.

For example, when the sensing data includes a plurality of pieces of sensing data, the data processing circuit 140 determines that, among the plurality of pieces of sensing data, items of sensing data with a correlation coefficient R of, for example, 0.3 or more have a significant correlation with the amount of change in first data 40 generated by the first NPU 120. The data processing circuit learns the multiple correlations between the amount of change in data generated by the first NPU 120 and the amount of change in sensing data and stores those items of the sensing data.

For example, when the sensing data includes data sensed from the torque sensor 310 and data sensed from the wheel speed sensor 340, the data processing circuit 140 may calculate each of the correlation coefficient R between the amount of change in the first data 40 during the first frame interval and the amount of change in the torque sensor input during the first frame interval, and the correlation coefficient R between the amount of change in the first data 40 during the first frame interval and the amount of change in the input of the wheel speed sensor during the first frame interval, and store items with a correlation coefficient R of, for example, 0.3 or more among the torque sensor input and the wheel speed sensor input in the memory 141.

Meanwhile, in step S200, the data processing circuit 140 may store the first data 40 and the second data 50 in the memory 141 during a second frame interval different from the previous first frame interval. Also, in step S201, the data processing circuit 140 may store the sensing data 60 during the second frame interval in the memory 141. Subsequently, in step S202, it is possible to compare whether the amount of change in the first data 40 during the second frame interval and the amount of change in the second data 50 during the second frame interval are equal to each other. At this time, if the amount of change in the first data 40 during the second frame interval and the amount of change in the second data 50 during the second frame interval are significantly different from each other (S202—N), it may be determined which of the first NPU 120 and the second NPU 130 operates abnormally, based on the result of learning in steps S203 and S204, and the sensing data 60 in the second frame interval received and stored from the sensing system 300 in step S201.

The data processing circuit 140 may calculate the first correlation coefficient R1 between the amount of change in the first data 40 during the second frame interval and the amount of change in the correlated sensing data during the second frame interval with respect to the item of correlated sensing data stored in step S204 (S205). In some implementations, if there are a plurality of items of the correlated sensing data that are determined to have a correlation with the amount of change in the first data 40 during the first frame interval in steps S203 and S204, the data processing circuit 140 may calculate correlation coefficients of the multiple correlations between the amount of change in the first data 40 during the second frame interval and the amount of change in each of the plurality of pieces of correlated sensing data during the second frame interval.

Subsequently, the data processing circuit 140 may calculate the second correlation coefficient R2 between the amount of change in the second data 50 during the second frame interval and the amount of change in the correlated sensing data during the second frame interval with respect to the item of correlated sensing data stored in step S204 (S206). In some implementations, if there are a plurality of items of correlated sensing data that are determined to have a correlation with the amount of change in the second data 50 during the first frame interval in steps S203 and S204, the data processing circuit 140 may calculate correlation coefficients of the multiple correlations between the amount of change in the second data 50 during the second frame interval and the amount of change in each of the plurality of pieces of correlated sensing data during the second frame interval.

Next, the data processing circuit 140 may compare the first correlation coefficient R1 and the second correlation coefficient R2 calculated in each of the steps S205 and S206, and determine whether the first correlation coefficient R1 is smaller than the second correlation coefficient R2 (S207). If the first correlation coefficient R1 is larger than the second correlation coefficient R2 (S207—N), the data processing circuit 140 may determine that the first NPU 120 corresponding to the main NPU operates normally.

However, if the first correlation coefficient R1 is smaller than the second correlation coefficient R2 (S207—Y), the data processing circuit 140 may determine that the first NPU 120 corresponding to the main NPU operates abnormally, and notify the driver of the vehicle 1000 of this fact (S208).

Referring to FIG. 9, in some implementations, if the first NPU 120 is determined to operate abnormally, the data processing circuit 140 may control the second NPU 130 to replace the operation of the first NPU 120. At this time, unlike FIG. 2, the first NPU 120 may not transmit the selected data 30 to the controller 150, and the second NPU 130 may transmit the second selected data 70 to the controller 150 instead of the first NPU 120. At this time, the second selected data 70 may be all of the plurality of pieces of second data 50 corresponding to each of the plurality of objects generated by performing the second image segmentation on the image 20 by the second NPU 130 in step S109 of FIG. 5. The controller 150 may control driving, startup, steering, and the like of the vehicle 1000 based on the second selected data 70 received from the second NPU 130 that is determined to operate normally.

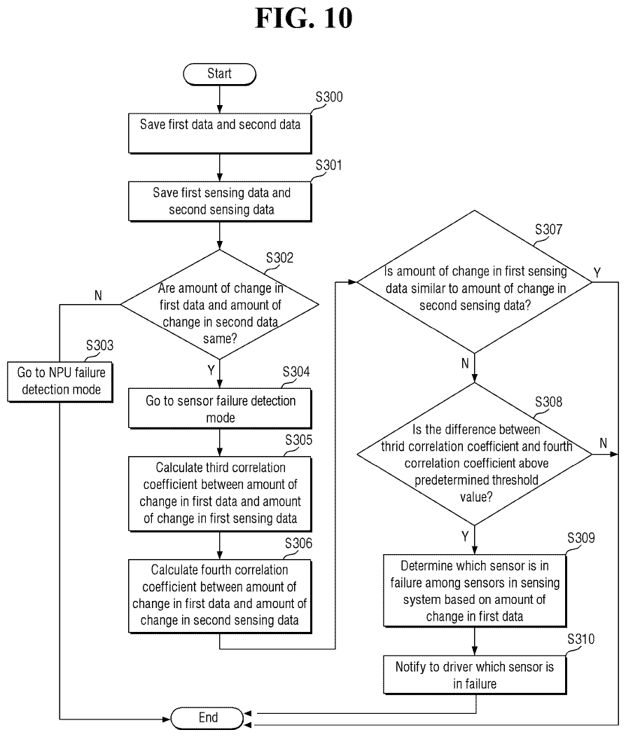

FIG. 10 is an exemplary flowchart for explaining the operation of the vehicle control system. Reference numbers in the following description may be the same as reference numbers in the drawings referred to above.

Referring to FIG. 10, the data processing circuit 140 may store the first data 40 and the second data 50 received from the first NPU 120 and the second NPU 130 in the memory 141 (S300). For example, the data processing circuit 140 may store the first data 40 during the third frame interval and the second data 50 during the third frame interval in the memory 141.

Further, the data processing circuit 140 may store the first sensing data and the second sensing data received from the sensing system 300 in the memory 141 (S301). For example, the data processing circuit 140 may store the first sensing data during the third frame interval and the second sensing data during the third frame interval in the memory 141. At this time, the first sensing data and the second sensing data may be data sensed by each of two different sensors among the plurality of sensors included in the sensing system 300. In the following description, a case will be explained as an example in which the first sensing data is sensing data sensed by the torque sensor 330 of the sensing system 300, and the second sensing data is sensing data generated by the wheel speed sensor 340 of the sensing system 300.

Next, the data processing circuit 140 may compare whether the amount of change in the first data 40 and the amount of change in the second data 50 are equal to each other (S302). For example, when the data processing circuit 140 receives the first data 40 during the third frame interval and the second data 50 during the third frame interval, the amount of change in the first data 40 during the third frame interval and the amount of change in the second data 50 during the third frame interval may be calculated, respectively.

If the amount of change in the first data 40 during the third frame interval and the amount of change in the second data 50 during the third frame interval show significantly different tendencies from each other (S302—N), the data processing circuit 140 may enter a NPU failure detection mode (S303). At this time, the NPU failure detection mode may correspond to steps S205 to S208 of FIG. 8.

On the other hand, if the amount of change in the first data 40 during the third frame interval and the amount of change in the second data 50 during the third frame interval show the same or similar tendency to each other (S302—Y), the data processing circuit 140 may enter the sensor failure detection mode (S304). That is, the data processing circuit 140 may determine that both the first NPU 120 and the second NPU 130 operate normally, if the amount of change in the first data 40 during the third frame interval and the amount of change in the second data 50 during the third frame interval show the same or similar tendency to each other. Therefore, in this case, unlike the NPU failure detection mode of step S303, the data processing circuit 140 may determine whether the sensors included in the sensing system 300 mounted on the vehicle 1000 fail, rather than whether the NPUs 120 and 130 of the vehicle control system 100 fail.

Subsequently, the data processing circuit 140 may calculate a third correlation coefficient R3 between the amount of change in the first data 40 during the third frame interval and the amount of change in the first sensing data during the third frame interval (S305). Furthermore, the data processing circuit 140 may calculate a fourth correlation coefficient R4 between the amount of change in the first data 40 during the third frame interval and the amount of change in the second sensing data during the third frame interval (S306). In this way, when both the first NPU 120 and the second NPU 130 are determined to operate normally, the data processing circuit 140 may determine whether the sensors fail, based on the amount of change in the selected data 30 generated by the first NPU 120 corresponding to the main NPU.

Next, the data processing circuit 140 compares the third correlation coefficient R3 with the fourth correlation coefficient R4, and may determine whether the amount of change in the first sensing data during the third frame interval and the amount of change in the second sensing data during the third frame interval show the same or similar tendency to each other (S307). At this time, if the amount of change in the first sensing data during the third frame interval and the amount of change in the second sensing data during the third frame interval show the same or similar tendency to each other (S307—Y), all sensors are determined to operate normally, and the sensor failure detection mode may be ended.

On the other hand, as a result of comparing the third correlation coefficient R3 with the fourth correlation coefficient R4, when the amount of change in the first sensing data during the third frame interval and the amount of change in the second sensing data during the third frame interval are different from each other or show different tendencies (S307—N), the data processing circuit 140 may determine whether a difference between the third correlation coefficient R3 and the fourth correlation coefficient R4 is equal to or greater than a predetermined threshold value (S308). At this time, the data processing circuit 140 may end the sensor failure detection mode, if the difference between the third correlation coefficient R3 and the fourth correlation coefficient R4 is equal to or less than a predetermined threshold value.

However, if the difference between the third correlation coefficient R3 and the fourth correlation coefficient R4 is equal to or greater than a predetermined threshold value, the data processing circuit 140 determines that there is an abnormality in at least one of the sensors, and may determine which sensor operates abnormally based on the amount of change in the first data 40 during the third frame interval (S309).

At this time, the data processing circuit 140 may compare the amount of change in the first data 40 during the third frame interval, the amount of change in the first sensing data during the third frame interval, and the amount of change in the second sensing data during the third frame interval. For example, a case where the first data 40 generated by the first NPU 120 is a reference coordinate of the bounding box will be explained. When the X value of the reference coordinate of the bounding box becomes increasingly large during the third frame interval, the data processing circuit 140 may determine that vehicle 1000 is turning left.

At this time, when the steering angle of the vehicle 1000 that is input from the steering angle sensor 350 corresponding to the first sensing data becomes increasingly large during the third frame interval, and the wheel speed sensor input of the vehicle 1000 that is input from the wheel speed sensor 340 corresponding to the second sensing data during the third frame interval becomes relatively larger on the left wheel of the vehicle 1000 than the right wheel, the data processing circuit 140 may determine that the wheel speed sensor 340 is abnormal.

That is, the data processing circuit 140 may compare the amount of change in the first data 40, the amount of change in the first sensing data, and the amount of change in the second sensing data during the third frame interval, and detect a sensor that shows a different tendency from the remaining outputs. Thereafter, the data processing circuit 140 may notify the driver of the vehicle 1000 of the abnormally operating sensor (S310).

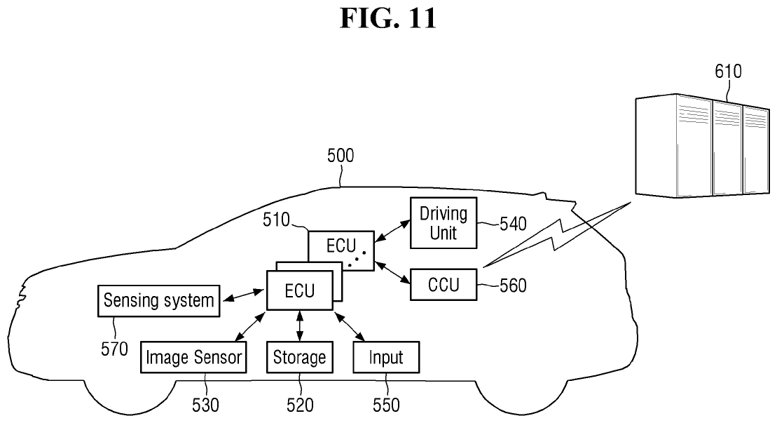

FIG. 11 is a diagram of a vehicle including the vehicle control system.

Referring to FIG. 11, a vehicle 500 may include a plurality of electronic control units (ECU) 510. Each electronic control unit of the plurality of electronic control units 510 is electrically, mechanically, and communicatively connected to at least one of the plurality of devices provided in the vehicle 500, and may control the operation of at least one device based on any one function execution command. The vehicle 500 may correspond to a vehicle 1000 of FIG. 3, and the vehicle control system 100 of FIGS. 1 and 2 may be included in the electronic control unit 510.

Here, the plurality of devices may include a storage device 520, an image sensor 530 that acquires an image required to perform at least one function, a driving unit 540 that performs at least one function, and a sensing system 570 including at least one sensor.

For example, the image sensor 530 may correspond to an automotive image sensor including a unit pixel, and the image sensor 530 may be included in the camera 200 of FIG. 2.

The driving unit 540 may include a fan and a compressor of an air conditioner, a fan of a ventilation device, an engine and a motor of a power device, a motor of a steering device, a motor and a valve of a brake device, an opening/closing device of a door or a tailgate, and the like.

The sensing system 570 may include at least one sensor that senses data about the driving states of the vehicle 500, and may correspond to the sensing system 300 of FIG. 2.

The plurality of electronic control units 510 may communicate with the storage device 520, the image sensor 530, the driving unit 540, the input unit 550, the CCU 560, and the sensing system 570, using at least one of, for example, an Ethernet, a low voltage differential signaling (LVDS) communication, and a LIN (Local Interconnect Network) communication.

The plurality of electronic control units 510 determine whether there is a need to perform the function based on the information acquired from the sensing system 530, and when it is determined that there is a need to perform the function, the plurality of electronic control units 510 control the operation of the driving unit 540 that performs that function, and may control an amount of operation based on the acquired information.

The plurality of electronic control units 510 are able to control the operation of the driving unit 540 that performs that function based on the function execution command that is input through the input unit 550, and are also able to check the setting amount corresponding to the information that is input through the input unit 550 and control the operation of the driving unit 540 that performs that function based on the checked setting amount.

Each electronic control unit 510 may control any one function independently, or may control any one function in cooperation with other electronic control units.

For example, the data processing circuit 140 (shown in FIG. 1) in the electronic control unit 510 may output a warning sound for an abnormal operation through a speaker, when there is an abnormality in the first NPU 120 (shown in FIG. 1) corresponding to the main NPU, or when there is an abnormality in any one of the sensors included in the sensing system 570.

An electronic control unit of an autonomous driving control device may receive navigation information, road image information, and distance information to obstacles in cooperation with the electronic control unit of the vehicle terminal, the electronic control unit of the image acquisition unit, and the electronic control unit of the collision prevention device, and control the power device, the brake device, and the steering device using the received information, thereby performing the autonomous driving.

A connectivity control unit (CCU) 560 is electrically, mechanically, and communicatively connected to each of the plurality of electronic control units 510, and communicates with each of the plurality of electronic control units 510.

That is, the connectivity control unit 560 is able to directly communicate with a plurality of electronic control units 510 provided inside the vehicle, is able to communicate with an external server, and is also able to communicate with an external terminal through an interface.

Here, the connectivity control unit 560 may communicate with the plurality of electronic control units 510, and may communicate with the server 610, using an antenna (not shown) and a RF communication.

Further, the connectivity control unit 560 may communicate with the server 610 by a wireless communication. At this time, the wireless communication between the connectivity control unit 560 and the server 610 may be performed through various wireless communication methods such as a GSM (Global System for Mobile communication), a CDMA (Code Division Multiple Access), a WCDMA (Wideband Code Division Multiple Access), a UMTS (Universal Mobile Telecommunications System), a TDMA (Time Division Multiple Access), and an LTE (Long Term Evolution), in addition to a Wifi module and a Wireless broadband module.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a combination can in some cases be excised from the combination, and the combination may be directed to a subcombination or variation of a subcombination.

While the present disclosure has been particularly illustrated and described with reference to exemplary implementations thereof, it will be understood by those of ordinary skill in the art that various changes in form and detail may be made therein without departing from the spirit and scope of the present disclosure as defined by the following claims. The exemplary implementations should be considered in a descriptive sense only and not for purposes of limitation.

What is claimed is:

1. A vehicle control system comprising:
an image signal processor (ISP) configured to receive first image data, the first image data defining a first image of an object around a vehicle during a first frame interval, and to process the first image data to generate second image data defining a second image;
a first neural processing unit (NPU) configured to receive the second image data from the ISP, to perform a first image segmentation on the second image data to identify a type of the object, and to generate first numerical data about a numerical value of a region occupied by the object within the second image;
a second NPU configured to receive the second image data from the ISP, to perform a second image segmentation on the second image data to identify the type of the object, and generate second numerical data about the numerical value of the region occupied by the object within the second image;
and
a data processing circuit configured to:
receive each of the first numerical data and the second numerical data from the first NPU and the second NPU;
receive sensing data about a driving state of the vehicle during the first frame interval from a sensing system;
process the first numerical data, the second numerical data, and the sensing data to indicate an abnormality state of each of the first NPU and the second NPU;
compare an amount of change in the first numerical data during the first frame interval and an amount of change in the second numerical data during the first frame interval; and
generate a correlation between an amount of change in the first numerical data during the first frame interval and an amount of change in the sensing data during the first frame interval based on identifying that the amount of change in the first numerical data during the first frame interval is equal to the amount of change in the second numerical data during the first frame interval.

2. The vehicle control system of claim 1,
wherein the sensing data includes a plurality of sensing data samples related to the driving state of the vehicle, and
the data processing circuit is configured to:
calculate correlation coefficients between the amount of change in the first numerical data during the first frame interval and the amount of change in each sensing data sample of the plurality of sensing data samples during the first frame interval; and
store at least a first sensing data sample that is determined to have a significant correlation with the amount of change in the first numerical data during the first frame interval, among the plurality of sensing data samples.

3. The vehicle control system of claim 2,
wherein the data processing circuit is configured to:
compare an amount of change in the first numerical data during a second frame interval with an amount of change in the second numerical data during the second frame interval, wherein the first frame interval is different from the second frame interval; and based on the comparison of the amount of change in the first numerical data during the second frame interval with the amount of change in the second numerical data during the second frame interval, determine the abnormality state of the first NPU and of the second NPU.

4. The vehicle control system of claim 3,
wherein the data processing circuit is configured to: calculate a first correlation coefficient between the amount of change in the first numerical data during the second frame interval and the amount of change in the first sensing data sample during the second frame interval;
calculate a second correlation coefficient between the amount of change in the second data during the second frame interval and the amount of change in the first sensing data sample during the second frame interval; and
compare the first correlation coefficient with the second correlation coefficient to determine the abnormality state of the first NPU and the second NPU.

5. The vehicle control system of claim 4,
wherein the data processing circuit is configured to determine that the first NPU operates abnormally in response to the first correlation coefficient being smaller than the second correlation coefficient, and to control the second NPU to replace the operation of the first NPU.

6. The vehicle control system of claim 1,
wherein the first NPU is configured to perform the first image segmentation on the second image data to generate a first bounding box that defines a first position of the object within the second image, and
the second NPU is configured to perform the second image segmentation on the second image data to generate a second bounding box that defines a second position of the object within the second image.

7. The vehicle control system of claim 6,
wherein the first numerical data includes data about a numerical value of the first bounding box, and
the second numerical data includes data about a numerical value of the second bounding box.

8. The vehicle control system of claim 7,
wherein the data about the numerical value of the first bounding box includes at least one of data about a first coordinate corresponding to a top left of the first bounding box, a first length of the first bounding box in a first direction, and a second length of the first bounding box in a second direction perpendicular to the first direction, and
the data about the numerical value of the second bounding box includes at least one of data about a second coordinate corresponding to a top left of the second bounding box, a third length of the second bounding box in the first direction, and a fourth length of the second bounding box in the second direction.

9. The vehicle control system of claim 1,
comprising the sensing system, wherein the sensing system includes at least one of an acceleration sensor, a gyroscope sensor, a torque sensor, a wheel speed sensor, and a steering angle sensor of the vehicle.

10. The vehicle control system of claim 1,
wherein the sensing system includes a first sensor that senses a first item related to the driving state of the vehicle to generate a first sensing data sample, and a second sensor that senses a second item related to the driving state of the vehicle and different from the first item to generate a second sensing data sample,
the data processing circuit is configured to:
calculate a first correlation coefficient between the amount of change in the first numerical data during a second frame interval and the amount of change in the first sensing data during the second frame interval;
calculate a second correlation coefficient between the amount of change in the first numerical data during the second frame interval and the amount of change in the second sensing data during the second frame interval; and
compare the first correlation coefficient with the second correlation coefficient to determine an abnormality state of the first sensor and the second sensor.

11. The vehicle control system of claim 10,
wherein the data processing circuit is configured to determine the abnormality state of the first sensor and the second sensor based on a difference between the first correlation coefficient and the second correlation coefficient being equal to or greater than a predetermined threshold value.

12. An automotive system comprising:
a camera configured to capture first image data defining a first image of an object around a vehicle during a first frame interval;
a sensing system configured to sense data related to a driving state of the vehicle during the first frame interval to generate sensing data; and
a vehicle control system configured to control the vehicle based on the first image data and the sensing data,
wherein the vehicle control system includes:
an image signal processor (ISP) configured to process the first image data to generate second image data defining a second image;
a first neural processing unit (NPU) configured to receive the second image data from the ISP, to perform a first image segmentation on the second image data to identify a type of the object, and to generate first numerical data about a numerical value of a region occupied by the object within the second image;
a second NPU configured to receive the second image data from the ISP, to perform a second image segmentation on the second image data to identify the type of the object, and to generate second numerical data about the numerical value of the region occupied by the object within the second image; and
a data processing circuit configured to
receive each of the first numerical data from the first NPU and the second numerical data from the second NPU,
receive the sensing data from the sensing system,
process the first numerical data, the second numerical data, and the sensing data to indicate an abnormality state of each of the first NPU or the second NPU,
compare an amount of change in the first numerical data during the first frame interval and an amount of change in the second numerical data during the first frame interval; and
generate a fcorrelation between an amount of change in the first numerical data during the first frame interval relative to an amount of change in the sensing data during the first frame interval based on identifying that the amount of change in the first numerical data during the first frame interval is equal to the amount of change in the second numerical data during the first frame interval.

13. The automotive system of claim 12,
wherein the vehicle control system further includes a controller configured to control the vehicle based on the first image data, and the controller is configured to control the vehicle based on information about the type of object from the first NPU, the first numerical data received from the first NPU if the amount of change in the first numerical data during the first frame interval is equal to the amount of change in the second numerical data during the first frame interval.

14. The automotive system of claim 12,
wherein the sensing data includes a plurality of pieces of sensing data obtained by sensing a plurality of items related to the driving state of the vehicle, and
the data processing circuit is configured to calculate each correlation coefficient between the amount of change in the first numerical data during the first frame interval and the amount of change in each of the plurality of pieces of sensing data during the first frame interval, and to store at least one item of sensing data, among the plurality of pieces of sensing data, that is determined to have a significant correlation with the amount of change in the first numerical data during the first frame interval,.

15. The automotive system of claim 14,
wherein if an amount of change in the first numerical data during a second frame interval, different from the first frame interval, is different from an amount of change in the second numerical data during the second frame interval, then
the data processing circuit is configured to
calculate a first correlation coefficient between the amount of change in the first numerical data during the second frame interval and an amount of change in the at least one sensing data during the second frame interval,
calculate a second correlation coefficient between the amount of change in the second numerical data during the second frame interval and the amount of change in the at least one sensing data during the second frame interval, and
compare the first correlation coefficient with the second correlation coefficient to determine whether any one of the first NPU or the second NPU is abnormal.

16. The automotive system of claim 15,
wherein the vehicle control system further includes a controller configured to control the vehicle based on the first image data and the sensing data, and
the data processing circuit is configured to determine whether the first NPU is in an abnormal state if the first correlation coefficient is smaller than the second correlation coefficient, and to allow the controller to control the vehicle, based on information about the type of the object from the second NPU and the second numerical data received from the second NPU.

17. The automotive system of claim 12,
wherein the first image data defines a plurality of objects around the vehicle during the first frame interval,
the first NPU is configured to perform the first image segmentation on the second image data to identify each type of the plurality of objects, and to tag a first plurality of confidence scores for each of the identified plurality of objects, and
the second NPU is configured to perform the second image segmentation on the second image data to identify each type of the plurality of objects, and to tag a second plurality of confidence scores for each of the identified plurality of objects.

18. The automotive system of claim 17,
wherein the first numerical data includes data about each numerical value of regions occupied by each of the plurality of objects within the second image identified by the first NPU,
the second numerical data includes data about each numerical value of regions occupied by each of the plurality of objects within the second image identified by the second NPU,
the first NPU is configured to transmit the first numerical data corresponding to each object having a high confidence score of the first plurality of confidence scores to the data processing circuit, and
the second NPU is configured to transmit the second numerical data corresponding to an object having a high confidence score of the second plurality of confidence scores to the data processing circuit.

19. A method for operating a vehicle control system, the method comprising:
receiving first image data defining a first image of an object around a vehicle during a first frame interval, and processing the first image data to generate second image data defining a second image, by an image signal processor (ISP);
receiving the second image data from the ISP, performing a first image segmentation on the second image data to identify a type of the object, and generating a first numerical data about a numerical value of a region occupied by the object within the second image, by a first neural processing unit (NPU);
receiving the second image data from the ISP, performing a second image segmentation on the second image data to identify the type of the object, and generating a second numerical data about the numerical value of the region occupied by the object within the second image, by a second NPU;
receiving each of the first numerical data from the first NPU and the second numerical data from the NPU, and receiving a plurality of pieces of sensing data about a driving state of the vehicle during the first frame interval from a sensing system, by a data processing circuit;
based on identifying that the amount of change in the first numerical data during the first frame interval is equal to the amount of change in the second numerical data during the first frame interval, calculating a first correlation between an amount of change in the first numerical data during the first frame interval and an amount of change in each of the plurality of pieces of sensing data during the first frame interval, by the data processing circuit; and
storing at least a first piece of sensing data of the plurality of pieces of sensing data that is determined to have a significant correlation with the amount of change in the first numerical data during the first frame interval, by the data processing circuit.

20. The method for operating the vehicle control system of claim 19, further comprising:
comparing, by the data processing circuit, whether an amount of change in the first numerical data during a second frame interval, different from the first frame interval, is different from the amount of change in the second numerical data during the second frame interval, to determine whether either the first NPU or the second NPU is in an abnormal state.
